(19) United States
(12) Patent Application Publication
(10) Pub. No.: US 2026/0365111 A1
(43) Pub. Date: Nov. 19, 2026

(54) IMAGE PROCESSING SYSTEM FOR A VEHICLE AND METHOD THEREOF

(71) Applicant: Motherson Innovations Company Limited, London (GB)

(72) Inventor: Romeo Wieczorek, Stuttgart (DE)

(21) Appl. No.: 19/674,542

(22) Filed: May 12, 2026

(30) Foreign Application Priority Data
May 16, 2025 (DE) 102025119042.9

(51) Int. Cl. B60R 1/26; B60R 1/25

(52) U.S. Cl. CPC B60R 1/26; B60R 1/25; B60R 2300/105; B60R 2300/304; B60R 2300/70; B60R 2300/802; B60R 2300/8046; B60R 2300/8066

(57) ABSTRACT

The present disclosure is directed to an image processing system for a vehicle including a first image capturing device configured to capture information of a first surrounding area of the vehicle comprising a surrounding segment and a vehicle segment of the vehicle, a second image capturing device configured to capture information of a second surrounding area of the vehicle such that the second surrounding area is at least partially overlapping to the first surrounding area, and an electronic control unit (ECU). The ECU is configured to receive and process the captured information of the first surrounding area and second surrounding area and to generate a composite image comprising the surrounding segment, the vehicle segment, and the second surrounding area such that the vehicle segment and the second surrounding area are overlaying each other. The ECU is configured to display a first image data set or a second image data set.

### CROSS-REFERENCE TO RELATED APPLICATIONS

This application claims the benefit of priority to German Patent Application DE 10 2025 119 042.9, filed on May. 16, 2025, which is incorporated herein by reference in its entirety.

### BACKGROUND

The present disclosure relates to an image processing system for a vehicle. Further, the present disclosure relates to a method for processing surrounding areas of a vehicle.

As automotive design evolves, one notable trend that has been observed is limitation posed by smaller rear windows in modern vehicles. This shift towards sleeker, more aerodynamic designs has inadvertently compromised visibility for drivers when looking back. Traditional rear windows, often larger and positioned to provide a comprehensive view of the road behind, are now being replaced by smaller glass panels that offer a restricted perspective. This reduction in size not only affects the driver's ability to see what is directly behind them but also complicates the integration of safety technologies aimed at enhancing rear visibility.

Moreover, the limitations imposed by smaller rear windows transcend mere visibility issues; they compel automotive designers and engineers to fundamentally reevaluate the traditional role of mirrors in vehicles. As visibility constraints grow, the conventional side mirrors and rear-view mirrors that drivers have relied on for decades are increasingly being replaced by advanced camera systems. These camera systems not only enhance visibility in tight spaces but also provide a broader perspective that traditional mirrors may fail to offer. However, the transition from mirrors to cameras introduces a new set of challenges, particularly concerning the optimal placement of the rear-view and side-view cameras within the vehicle's design. The positioning of these cameras is critical; they must be strategically located to maximize their effectiveness while also adhering to aesthetic considerations and regulatory standards. Proper placement ensures that drivers can achieve an unobstructed view of their surroundings, which is essential for safe maneuvering and parking.

### SUMMARY

Against the background, it is an object of the present disclosure to provide an image processing system providing combined view of both rear and side based on predefined condition of the vehicle to a person who is driving.

At least one of these objects is achieved by an image processing system having the features of claim 1 and/or by a vehicle having the features of claims 1–9.

According to an aspect of the present disclosure, an image processing system for a vehicle is disclosed. The image processing system comprises a first image capturing device configured to capture information of a first surrounding area of the vehicle and a second image capturing device configured to capture information of a second surrounding area of the vehicle. The first surrounding area comprises a surrounding segment and a vehicle segment of the vehicle and the second surrounding area is at least partially overlapping to the first surrounding area. The system further comprises an electronic control unit (ECU) comprising an image processor. The ECU is configured to receive and process the captured images of the first and second surrounding areas, to generate a composite image. The composite image comprises the surrounding segment, the vehicle segment and the second surrounding area. The vehicle segment and the second surrounding area are configured to overlay in the composite image.

The ECU is configured to display a first image data set having a transparent representation of the vehicle segment in the composite image and a second image data set having a semi-transparent representation of the vehicle segment in the composite image over the display device based on at least one predefined condition.

In an embodiment, the ECU is configured to display the first image data set, displayed when the vehicle is moving in forward direction above a predefined speed.

In an embodiment, the ECU is configured to display the second image data set, displayed when the vehicle is either stationary, moving in backward direction, and/or moving in forward direction up to a predefined speed.

In an embodiment, the ECU is configured to display the first image data set having a transparent representation of the vehicle segment when the vehicle is moving in backward direction having a preset distance of an obstacle free path.

In an embodiment, the first image capturing device comprises a first mounting interface that is configured and arranged such to attach the first image capturing device at an exterior of an A-pillar of the vehicle. The second image capturing device comprises a second mounting interface that is configured and arranged such to attach the second image capturing device at an exterior rear end of the vehicle.

In an embodiment, the image processing system further comprises a third and fourth image capturing devices configured to be attached to an exterior co-passenger side of the vehicle and to an exterior rear end on the co-passenger side of the vehicle, respectively.

In an embodiment, the third and fourth image capturing devices captures information of the surrounding environment and the image processor processes the captured information to generate the composite image.

According to another aspect of the present disclosure, a method for processing the information of first and second surrounding areas of a vehicle by the image processing system according to claims 1 to 9 is disclosed. The method comprises step S1 of providing the image processing system followed by step S2 of capturing, by a first image capturing device, a first surrounding area comprising a surrounding segment and a vehicle segment of the vehicle and step S3 of capturing, by a second image capturing device, a second surrounding area of the vehicle. Step S4 comprises receiving, by an ECU, the captured first and second surrounding areas and step S5 comprises processing, by an image processor, the received first and second surrounding areas, to generate a composite image comprising the surrounding segment, the vehicle segment and the second surrounding segment. In an embodiment, the second surrounding area is at least partially overlapping to the first surrounding area.

In an embodiment, the method further comprises a step of displaying, by a display device, based on at least one predefined condition, a first image data set having a transparent representation of the vehicle segment in the composite image or a second image data set having a semi-transparent representation of the vehicle segment in the composite image. The vehicle segment and the second surrounding areas are configured to overlay each other in the composite image.

In an embodiment, the method further comprises capturing, by a third and fourth image capturing devices, information of the surrounding environment of the vehicle and processing, by the image processor, the captured information to generate the composite image.

The present disclosure is also related to a vehicle with the image processing system as described above.

The image processing system of the present disclosure incorporates a precise amalgamation of the images captured by two image capturing devices. The image processing system not only enhances the driver’s ability to navigate tight spaces or merge safely into traffic but also contributes to an overall safer driving experience by providing a clear, unobstructed view of potential obstacles and hazards in the blind spots at the rear of the vehicle. Such systems represent a significant advancement in vehicle safety features, ultimately aiming to reduce accidents and improve driver confidence on the road.

It should be noted that the features set out individually in the following description can be combined with each other in any technically advantageous manner and set out other forms of the present disclosure. It should be understood, however, that the disclosure is not limited to the precise arrangements and instrumentalities shown. The accompanying drawings, which are incorporated in and constitute a part of this specification, illustrate an implementation of system, apparatuses, and methods consistent with the present description and, together with the description, serve to explain advantages and principles consistent with the disclosure. The figures are not necessarily drawn to scale. Like numbers used in the figures refer to like components. However, it will be understood that the use of a number to refer to a component in a given figure is not intended to limit the component in another figure labelled with the same number. The description further characterizes and specifies the present disclosure in particular in connection with the Figures.

### BRIEF DESCRIPTION OF THE DRAWINGS

Other aspects, advantages, and salient features of the present disclosure will become apparent to those skilled in the art from the following detailed description, which taken in conjunction with the annexed drawings, discloses exemplary embodiments of the disclosure, wherein:

FIG. 1 illustrates a block diagram of an image processing system according to an embodiment of the present disclosure;

FIG. 2A illustrates a schematic view of the image processing system according to an embodiment of the present disclosure;

FIG. 2B illustrates a perspective view of a composite image according to an embodiment of the present disclosure;

FIGS. 3A & 3B illustrate a perspective view of first and second image data sets respectively according to an embodiment of the present disclosure; and

FIG. 4 illustrates a method for processing captured areas according to an embodiment of the present disclosure.

### DETAILED DESCRIPTION

The foregoing objects, features and advantages of the present disclosure will become more apparent from the following detailed description related to the accompanying drawings. However, various modifications may be applied to the present disclosure, and the present disclosure may have various embodiments of the present disclosure. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the drawings, the thicknesses of layers and regions may be exaggerated for clarity. When it is indicated that an element or layer is “on” or “above” another element or layer, this comprises a case in which another layer or element is interposed therebetween as well as a case in which the element or layer is directly above the other element or layer. In principle, reference signs designate elements throughout the specification. In the following description, the same reference signs are used to designate elements, which have the same function within the same idea illustrated in the drawings of each embodiment of the present disclosure.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

In addition, the terms “module” and “unit” used to refer to elements in the following description are given or used in combination only in consideration of ease of writing the specification, and the terms themselves do not have distinct meanings or roles.

Furthermore, the use of a singular term, such as, “a” is not to be interpreted as limiting the number of components or details of particular components. Additionally, various terms and/or phrases describing or indicating a position or directional reference such as, but not limited to, “top”, “bottom”, “front”, “rear”, “forward”, “rearward”, “end”, “outer”, “inner”, “left”, “right”, “vertical”, “horizontal”, etc. may relate to one or more particular components as seen generally from a user’s vantage point during use or operation, and such terms and/or phrases are not to be interpreted as limiting, but merely as a representative basis for describing the disclosure to one skilled in the art. In addition, a suffix "region", "part", "unit" for a component used in the following description are given or mixed in consideration of only the ease of writing the specification, and do not have meanings or roles distinguished from each other.

The present disclosure provides an image processing system comprising a first and second image capturing devices configured to capture a first and a second surrounding areas of a vehicle respectively. The first surrounding area comprises a surrounding segment and a vehicle segment and the second surrounding area is at least partially overlapping to the first surrounding area. The system further comprises an electronic control unit (ECU) having an image processor and configured to receive and process the captured first and second surrounding areas via the image processor to generate a composite image. The composite image comprises the surrounding segment, the vehicle segment and the second surrounding area such that the vehicle segment and the second surrounding area are overlaying each other. The ECU is configured to display on a display device either a first image data set having a transparent representation of the vehicle segment or a second image data set having a semi-transparent representation of the vehicle segment in the composite image based on at least one predefined condition.

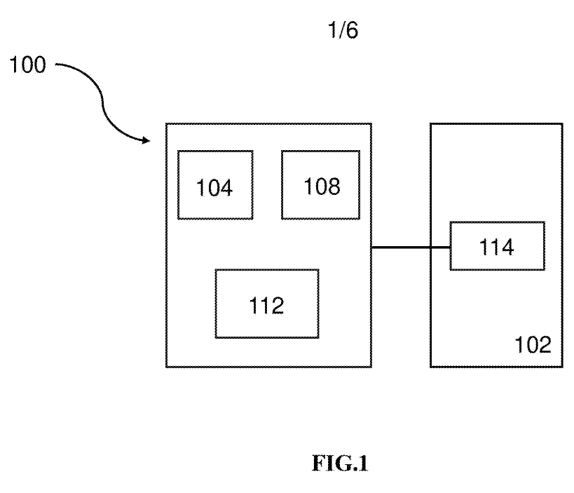

FIG. 1 illustrates a block diagram representing an image processing system 100 configured for a vehicle 102 with an aspect of the present disclosure. The image processing system 100 comprises two distinct image capturing devices such as a first image capturing device 104 and a second image capturing device 108. The first and second image capturing devices 104, 108 are configured to work in tandem to capture comprehensive information of the vehicle's surroundings. The image processing system 100 further comprises an electronic control unit (ECU) 112, which plays a critical role in managing the data flow. The ECU 112 is configured to receive the captured information by the first and second image capturing devices 104, 108 and subsequently processes the captured information using an integrated image processor. This processing may involve various algorithms to analyze the images for obstacles, lane markings, and other pertinent environmental features.

To facilitate user interaction and enhance the driving experience, a display device 114 is configured to be mounted within interior of the vehicle 102. The display device 114 serves an essential function of presenting the processed information in a clear and accessible manner, enabling the driver to make informed decisions based on real-time visual feedback from the vehicle's surroundings.

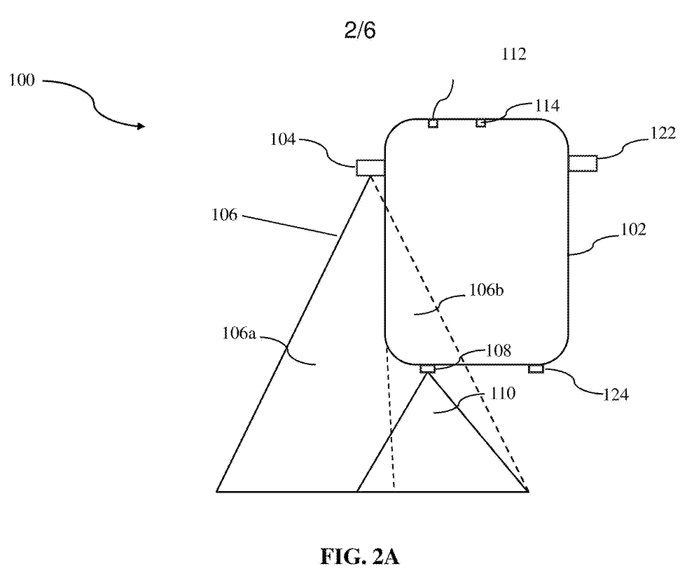

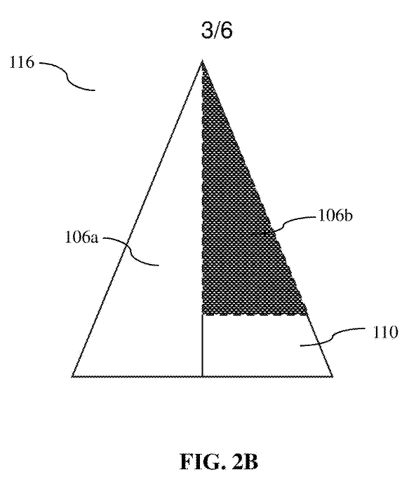

FIG. 2A displays a schematic view of the image processing system 100 with the vehicle 102. The first image capturing device 104 is strategically positioned to focus on information related to a first surrounding area 106 of the vehicle 102, allowing it to capture essential visual information relevant to that space. The second image capturing device 108 is configured to capture information of a second surrounding area 110 of the vehicle 102. The first surrounding area 106 comprises a surrounding segment 106a and a vehicle segment 106b. Further, the second surrounding area 110 is at least partially overlapping to the first surrounding area 106.

The first and second image capturing devices 104, 108 of the present system 100 enhances the system's ability to gather comprehensive visual data. The ECU 112 plays a pivotal role in this process by receiving the captured information of both the first and second areas 106, 110. Once the captured information is received, the ECU 112 is configured to process the captured information through the integrated image processor. This processing step is crucial as it transforms the raw visual input into actionable information that can assist the driver, such as identifying obstacles or providing alerts about the vehicle's environment. Overall, the design of the image processing system 100 as depicted in FIG. 2A underscores its advanced capabilities in enhancing vehicle safety and situational awareness on the road.

In one embodiment of the image processing system 100, the first image capturing device 104 comprises a first mounting interface configured and arranged such to attach the first image capturing device to an exterior of vehicle 102, ensuring optimal visibility and functionality. This positioning allows the device to effectively capture real-time images of the vehicle's immediate surroundings, enhancing the system's ability to monitor areas that may not be visible to the driver. Additionally, the second image capturing device 108 comprises a second mounting interface configured and arranged such to attach the second image capturing device 108 at an exterior rear end of the vehicle 102, as illustrated in FIG. 2A. This rear positioning is particularly advantageous for monitoring blind spots behind the vehicle 102. By incorporating the two strategically placed first and second image capturing devices 104, 108, the image processing system 100 maximizes its surveillance capabilities, ensuring comprehensive coverage of the vehicle's surroundings.

In an embodiment, the first and second image capturing devices 104, 108 may be any appropriate camera or sensor. If desired, the image data capturing devices 104, 108 can be a "smart camera," encompassing an imaging sensor array along with related circuitry, image processing circuitry, electrical connectors, and similar components within a camera module.

In an embodiment, the ECU 112 is configured to generate a composite image 116 comprising the surrounding segment 106a, the vehicle segment 106b and the second surrounding area 110 derived from the processed information of both the first surrounding area 106 and the second surrounding area 110 as depicted in FIG. 2B. This functionality is particularly significant as it allows the ECU 112 to synthesize visual data into a cohesive and informative representation that encapsulates the key features of the vehicle's rear surroundings.

In an embodiment, the first surrounding area 106 and the second surrounding area 110 are specifically rear view areas of the vehicle 102, which are crucial for enhancing safety and visibility while driving. These areas are typically designed to provide the driver with a clear view of the surroundings behind the vehicle, allowing for better situational awareness when reversing or changing lanes.

In an embodiment, the ECU 112 is further configured to display the generated composite image 116 over a display device 114. The display device 114 is configured to be mounted at an interior of the vehicle 102. The composite image 116 may be a stitched image of the first surrounding area 106 and the second surrounding area 110.

By analyzing the information captured from the first and second surrounding areas 106, 110, the ECU 112 stitches and enhance this visual information, creating a comprehensive view in the form of the composite image 116 that may highlight critical elements such as rear obstacles, traffic conditions, and lane markings. The generation of the composite image 116 can serve multiple purposes, from providing a clearer visual context for the driver. Additionally, such representations can be tailored to suit different driving scenarios, ensuring that the driver receives the most relevant and useful information in real-time. This embodiment emphasizes the role of ECU 112 role not only as a data processor but also as a pivotal element in transforming raw visual inputs into actionable insights, ultimately enhancing the driver's situational awareness and safety on the road.

In an embodiment, image stitching is a technique that merges multiple photographs with or without overlapping fields of view to create a cohesive single image. The process involves several essential steps, starting with the calibration of individual images to ensure consistency in exposure and lighting. Once calibrated, the images undergo a registration phase, where they are aligned using either direct methods or feature-based image alignment techniques. This alignment is crucial for determining the correct orientation and overlap of the images, allowing for a seamless transition between them. Post alignment, blending process is carried which not only combines the overlapping sections but also corrects any errors or distortions that may have occurred during the initial capturing of the images.

Additionally, image stitching can be enhanced by incorporating image transformation techniques, which allow for the generation of stitched images from different perspectives. For instance, by altering the perceived viewing angle such as creating an aerial view instead of a traditional elevational view, one can achieve a more dynamic and varied representation of the scene. Through these processes, image stitching produces impressive visuals that capture a broader perspective of the environment.

In an embodiment, the vision system 100 may be configured to have a third and fourth image capturing devices 122, 124, which are mounted on the exterior co-passenger side of the vehicle 102 and on the exterior rear end on the co-passenger side of the vehicle 102, respectively, specifically on its right side and the first and second image capturing devices 104, 108 are configured to be mounted at the exterior of driver side A-pillar and at the exterior rear end on driver side of the vehicle 102, respectively.

The placement of the third and fourth image capturing device 122, 124 enables the vision system 100 to effectively capture, monitor and gather information about the environment immediately adjacent to the right side of the vehicle 102, allowing for enhanced situational awareness. Further, the information captured may be processed and integrated with the information captured by first and second image capturing devices 104, 108. This integration process facilitates representation of a comprehensive and expansive view of the rear surroundings of the vehicle 102 and generation of the composite image 116. The combination of data from the first and second image capturing devices 104, 108 and the third and fourth image capturing devices 122, 124 significantly enhances the ability of the vision system 100 to perceive and interpret the environment around the vehicle 102, providing information which is not readily available to the driver, thereby improving safety by reducing blind spots, aiding decision-making processes and allowing the vehicle 102 to respond more effectively to dynamic road conditions and potential obstacles.

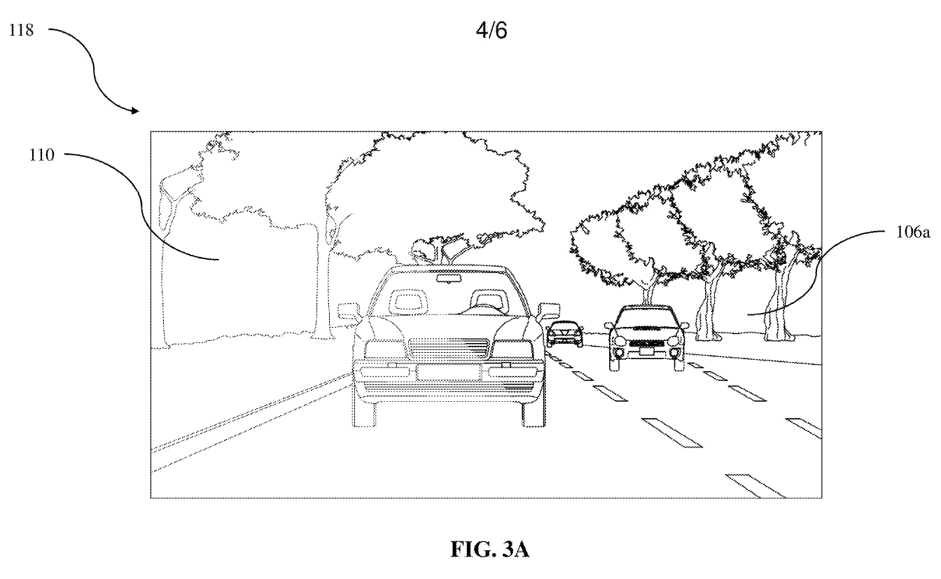

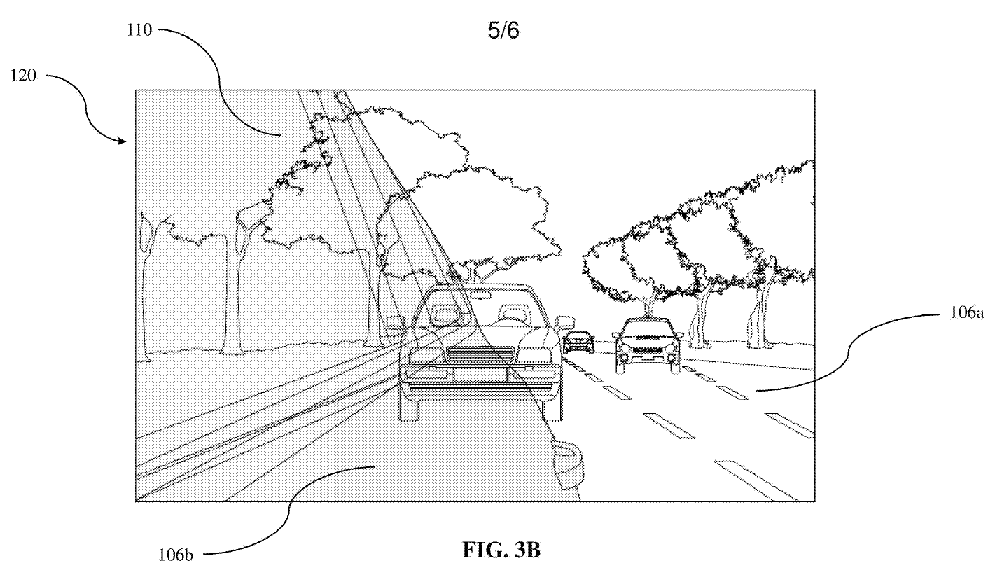

FIGS. 3A and 3B illustrate the generated composite image 116 in the form of a first image data set 118 and a second image data set 120 respectively. The ECU 112 is configured to display on the display device 114, the first image data set 118 having a transparent representation of the vehicle segment 106b in the composite image, which indicates a specific scenario in which the vehicle 102 is traveling forward at a speed exceeding a predefined speed threshold. This transparency allows for a clearer view of the rear surrounding while the vehicle is in motion, enhancing situational awareness and enabling better navigation through the environment.

FIG. 3B shows the second image data set 120 having a semi-transparent representation of the vehicle segment 106b in the composite image 116, which is utilized in scenarios where the vehicle is either stationary, reversing, or moving forward at speeds that do not exceed the predefined speed threshold. This semi-transparency serves to provide a balance between visibility of the own vehicle and the need for drivers to be aware of their immediate rear surroundings, especially in slower or stationary conditions. By employing the first and second image data sets 118, 120, the image processing system 100 effectively conveys different operational conditions of the vehicle 102, facilitating improved interaction with the environment and promoting safer driving practices.

In an embodiment, the predefined speed threshold of the vehicle 102 may be 30 km/hr. More preferably, the predefined speed threshold may be 25 km/hr. More preferably, the predefined speed threshold may be 20 km/hr. More preferably, the predefined speed threshold may be 16 km/hr.

In an embodiment, when the vehicle 102 is in reverse motion and the pathway behind it is clear of any obstacles up to a preset distance, the display device 114 is configured to display the first image data set 118 having a transparent representation of the vehicle segment 106b in the composite image 116. This approach serves to enhance the driver's situational awareness by allowing them to maintain visibility of the environment while simultaneously monitoring the area behind the vehicle 102. The transparency of the vehicle segment 106b indicates that there are no obstacles or hazards within the preset distance, thereby providing a sense of safety and confidence as the vehicle 102 backs up. By utilizing the transparent representation, the ECU effectively communicates to the driver that they can proceed without immediate concern for potential collisions or impediments. This feature is particularly valuable in tight spaces or crowded environments, where visibility can be compromised, and the risk of accidents is heightened.

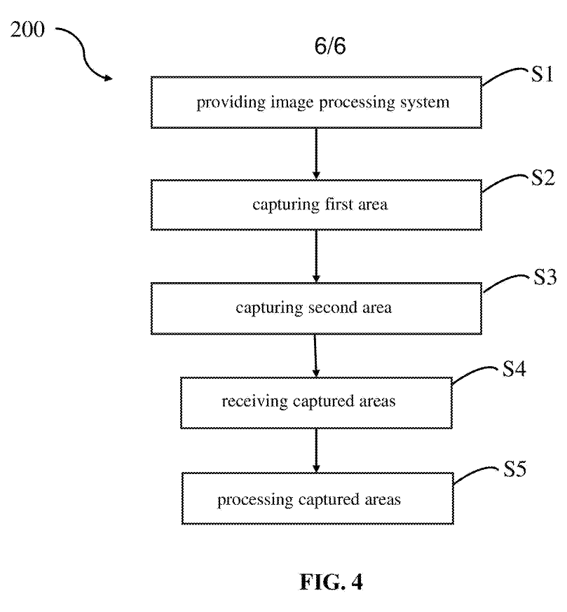

In an embodiment, the preset distance may be 30 meters. More preferably, the preset distance may be 20 meters, more preferably, the preset distance may be 10 meters. In another aspect of the present disclosure, a method 200 for processing the information of first and second surrounding areas 106, 110 is disclosed as shown in FIG. 4. The method 200 comprises step S1 of providing the image processing system 100 followed by step S2 of capturing, by a first image capturing device 104, information of a first surrounding area 106 that comprises a surrounding segment 106a and the vehicle segment 106b and step S3 of capturing, by a second image capturing device 108, information of a second surrounding area 110. Step S4 involves receiving, by the ECU 112, the captured information of the first and second surrounding areas 106, 110. This step is crucial as it consolidates the visual data necessary for further analysis. Following this, step S5 involves processing, by an image processor of the ECU, the received captured information to generate a composite image 116 comprising the surrounding segment 106a, the vehicle segment 106b and the second surrounding segment 110 in which the vehicle segment 106b and the second surrounding area 110 are configured to overlay each other.

The method 200 further comprises step of displaying, by the display device 114, a first image data set 118 having a transparent representation of the vehicle segment 106b or a second image data set 120 having a semi-transparent representation of the vehicle segment 106b in the composite image 116 based on at least one predefined condition.

The display device 114 is mounted within the vehicle for easy visibility by the driver. This essential as the display device 114 presents the processed information in a user-friendly format, enabling the driver to make informed decisions based on a clear and comprehensive view of the environment surrounding the rear of the vehicle 102.

In an embodiment, the first image data set 118 is displayed when the vehicle 102 is moving forward above a predefined speed and the second image data set 120 is displayed when the vehicle is stationary, moving backwards and/or moving forward up to the predefined speed.

In an embodiment, the rear obstacles encountered can encompass a diverse range of entities, including vehicles, bicycles, motorcycles, humans, and stationary objects such as walls during parking. This comprehensive categorization is crucial for enhancing the safety and efficiency of parking operations, as it acknowledges the various potential hazards that may be present in the rear environment. For instance, vehicles may include cars or trucks that could be parked or moving in the vicinity, while bicycles and motorcycles represent smaller, more agile obstacles that might not be immediately visible to the driver. Additionally, the presence of pedestrians introduces another layer of complexity, as their movement patterns can be unpredictable. Finally, walls or other structural obstacles could pose a significant risk if they are not accounted for during the reverse parking process.

Although the subject matter of the present disclosure has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims. i.e. the features disclosed in the foregoing description, the claims, and the drawings may be essential, both individually and in any combination, for accomplishing the present disclosure in its various embodiments. The embodiments shown herein are only examples of the present disclosure and must therefore not be understood as being restrictive. Alternative embodiments considered by the skilled person are equally covered by the scope of protection of the present disclosure.

### REFERENCE SIGNS LIST

100 an image processing system

102 vehicle

104 first image capturing device

106 first surrounding area

106a surrounding segment

106b vehicle segment

108 second image capturing device

110 second surrounding area

112 electronic control unit (ECU)

114 display device

116 composite image

118 first image data set

120 second image data set

122 third image capturing device

124 fourth image capturing device

What is claimed is:

1. An image processing system for a vehicle, the image processing system comprising:
a first image capturing device configured to capture information of a first surrounding area of the vehicle, wherein the first surrounding area comprises a surrounding segment and a vehicle segment of the vehicle;
a second image capturing device configured to capture information of a second surrounding area of the vehicle, wherein the second surrounding area is at least partially overlapping to the first surrounding area; and
an electronic control unit (ECU) comprising an image processor configured to receive and process the captured information of the first surrounding area and second surrounding area and to generate a composite image comprising the surrounding segment, the vehicle segment, and the second surrounding area such that the vehicle segment and the second surrounding area are overlaying each other, wherein the ECU is configured to display on a display device:
a first image data set having a transparent representation of the vehicle segment in the composite image; or
a second image data set having a semi-transparent representation of the vehicle segment in the composite image.

2. The image processing system according to claim 1, wherein the ECU is configured to display the first image data set and the second image data set based on at least one predefined condition.

3. The image processing system according to claim 1, wherein the ECU is configured to display the first image data set on the display device when the vehicle is moving in forward direction and above a predefined speed threshold.

4. The image processing system according to claim 3, wherein the ECU is configured to display the second image data set when the vehicle is either stationary, moving in backward direction and/or moving in forward direction up to the predefined speed threshold.

5. The image processing system according to claim 1, wherein the ECU is configured to display on the display device the first image data set having a transparent representation of the vehicle segment when the vehicle is moving in backward direction having a preset distance of an obstacle free path.

6. The image processing system according to claim 1, wherein the first image capturing device comprises a first mounting interface configured to attach the first image capturing device at an exterior of a driver side A-pillar of the vehicle.

7. The image processing system according to claim 1, wherein the second image capturing device comprises a second mounting interface configured to attach the second image capturing device at an exterior rear end on a driver side of the vehicle.

8. The image processing system according to claim 1, further comprising a third image capturing device and fourth image capturing device configured to be attached to an exterior co-passenger side of the vehicle and to an exterior rear end on the co-passenger side of the vehicle, respectively.

9. The image processing system according to claim 8, wherein the third image capturing device and fourth image capturing device capture information of a surrounding environment and wherein the image processor processes the captured information to generate the composite image.

10. A method for processing information of a first surrounding area and a second surrounding area of a vehicle, the method comprising following steps:
providing (S1) an image processing system;
capturing (S2), by a first image capturing device, information of the first surrounding area comprising a surrounding segment and a vehicle segment of the vehicle;
capturing (S3), by a second image capturing device, information of the second surrounding area of the vehicle;
receiving (S4), by an electronic control unit (ECU), the captured information of the first surrounding area and second surrounding area; and
processing (S5), by an image processor of the ECU, the received information of the first surrounding area and second surrounding area, to generate a composite image comprising the surrounding segment, the vehicle segment and the second surrounding area,
wherein the vehicle segment and the second surrounding area are configured to overlay each other.

11. The method according to claim 10, further comprising the step of: displaying, on a display device, a first image data set having a transparent representation of the vehicle segment or a second image data set having a semi-transparent representation of the vehicle segment in the composite image.

12. The method according to claim 11, wherein the first image data set and the second image data set are displayed based on at least one predefined condition.

13. The method according to claim 11 further comprising capturing information, by a third image capturing device and fourth image capturing device, of a surrounding environment of the vehicle and processing, by the image processor, the captured information to generate the composite image.

14. A vehicle comprising an image processing system according to claim 1.
